(19) United States
(12) Patent Application Publication
(10) Pub. No.: US 2007/0087826 A1
(43) Pub. Date: Apr. 19, 2007

(54) Graph making system and method

(75) Inventors: Chaucer Chiu, Taipei (TW); Hepe Tang, Taipei (TW); Strong Huang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION, Taipei (TW)

(21) Appl. No.: 11/386,668

(22) Filed: Mar. 23, 2006

(30) Foreign Application Priority Data
Oct. 17, 2005 (TW) 094136115

(51) Int. Cl. A63F 13/00

(52) U.S. Cl. 463/31

(57) ABSTRACT

A graph making system and method for designing and making graphs is proposed. The graph making system includes a database, a decomposing module, a setting module and a filling module, wherein, the database stores various types of basic templates and basic graphic units corresponding to the various types of basic templates. According to the graph making method of the present invention, a graphic baseplate is decomposed into a plurality of graphic chips firstly. Thereafter, a required basic template is selected from the database. Then, basic graphic units contained in the basic template are filled into the graphic chips at corresponding positions respectively so as to form various entitative graphs with different shapes. Thus, an integral graph can be obtained. The present invention can significantly increase working efficiency for drafting staffs, and also can efficiently save computer resources, and upgrade operation speed of system programs.

### BACKGROUND OF THE INVENTION

1. Field of the Invention

The present invention relates generally to a graph making technology, and more particularly to a graph making system and method which makes game graphs by combining a plurality of units.

2. Description of Related Art

With popularization of computers, computer games are making a significant impact on people's life and nearly developed as a new culture.

Whether game scene pictures are attractive or not is not only an important factor in evaluating quality of a computer game, but also an important factor in attracting game players especially when players play the game for the first time. For game developers, even if a game is made very well, if there is no good picture effect, the game can hardly attract game players. Thus, a lot of game developers devote themselves to making techniques of scene pictures.

A computer game picture is usually composed of scenes, characters, effects and interfaces, wherein, the scenes are a most important part of the computer game picture. However, at present, scene pictures of a computer game are usually drafted by using a traditional drafting software, which is rather complex and often leads to low working efficiency. In addition, the more excellent a game picture is, the much higher requirement is needed for a computer device, which consequentially increases the cost of playing games, thereby adversely affecting the spread of the computer game. Thus, there exists a strong need in the art for a graph making technology to solve the above-described drawbacks of conventional technology efficiently.

### SUMMARY OF THE INVENTION

According to the above drawbacks, it is an objective of the present invention to provide a graph making system and method, which can improve graph making efficiency and save time for designers.

It is another objective of the present invention to provide a graph making system and method, which can save computer resources and upgrade operation speed of system programs.

It is a further objective of the present invention to provide a graph making system and method, which can upgrade game picture quality, and increase game interest.

In order to attain the above and other objectives, a graph making system and method applicable in a computer device for designing and making graphs is provided according to the present invention. The graph making system includes a database for storing various types of basic templates and basic graphic units corresponding to the various types of basic templates; a decomposing module for creating a graphic baseplate, and decomposing the graphic baseplate into a plurality of graphic chips; a setting module for selecting a basic template type from the database according to design requirement, and acquiring basic graphic units corresponding to the basic template type from the database; and a filling module for filling the basic graphic units into the graphic chips at corresponding positions respectively, so as to form various entitative graphs with different shapes, thereby obtaining an integral graph. Therein, the basic templates are classified according to entitative types thereof. Shape and size of the plurality of graphic chips can be the same or different from each other. The basic graphic units and the graphic chips into which the basic graphic units are filled are matched in shape and size. In addition, the graph making system further includes a decorating module for decorating the basic graphic units corresponding to actual requirements.

A graph making method applicable in a computer device for designing and making graphs through a graph making system is provided according to the present invention, wherein, the graph making system has a database for storing various types of basic templates and basic graphic units corresponding to the various types of basic templates. The graph making method includes the steps of: (1) creating a graphic baseplate, and decomposing the graphic baseplate into a plurality of graphic chips; (2) setting a required basic template type and acquiring basic graphic units corresponding to the basic template type from the database; (3) and filling the basic graphic units into the graphic chips at corresponding positions respectively, so as to form various entitative graphs with different shapes, thereby obtaining an integral graph. Therein, the basic templates are classified according to entitative types thereof. Shape and size of the graphic chips formed in step (1) can be the same or different from each other. In Step (3), the basic graphic units and the graphic chips into which the basic graphic units are filled are matched in shape and size. The graph making method further includes a step of decorating the basic graphic units based upon actual requirements.

As described above, the graph making system and method according to the present invention combines a plurality of basic graphic units so as to form various entitative graphs with different shapes and textures, thereby obtaining an integral graph. Thus, the present invention upgrades drafting efficiency and efficiently saves computer resources. Moreover, computer games can become much more flavored with optimized display quality of game pictures through the present invention.

### BRIEF DESCRIPTION OF DRAWINGS

FIG. 1 is a schematic diagram of a basic structure of a graph making system according to the present invention.

FIGS. 2A to 2F depict some basic templates and corresponding basic graphic units that need to be stored in a database of the graph making system according to the present invention.

FIGS. 3A and 3B are schematic diagrams showing different combinations of the basic graphic units of a graph making system according to a preferred embodiment of the present invention.

FIG. 4 depicts a flow chart of a graph making method according to the present invention.

FIGS. 5A to 5F depict schematic diagrams of a preferred embodiment of the graph making method according to the present invention.

### DETAILED DESCRIPTION OF PREFERRED EMBODIMENTS

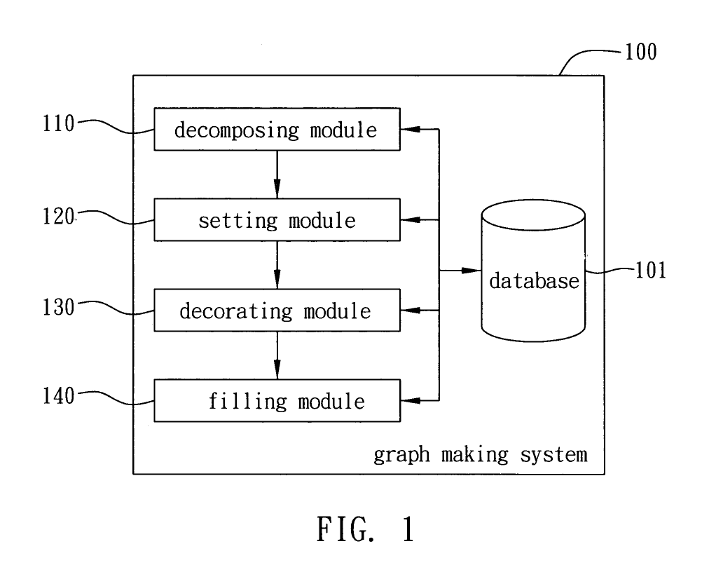

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be devised without departing from the spirit of the present invention. FIG. 1 is a schematic block diagram of the basic structure of a graph making system 100 according to the present invention. The graph making system 100 according to the present invention can be applied in a computer device (not illustrated) to allow computer game developers to design and make three-dimensional scene pictures of a computer game. As show in FIG. 1, the graph making system 100 comprises a database 101, a decomposing module 110, a setting module 120, a decorating module 130 and a filling module 140.

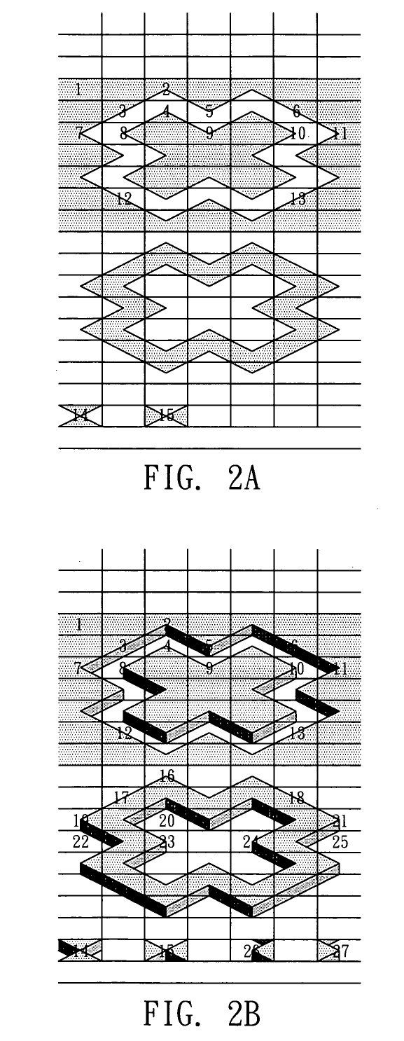

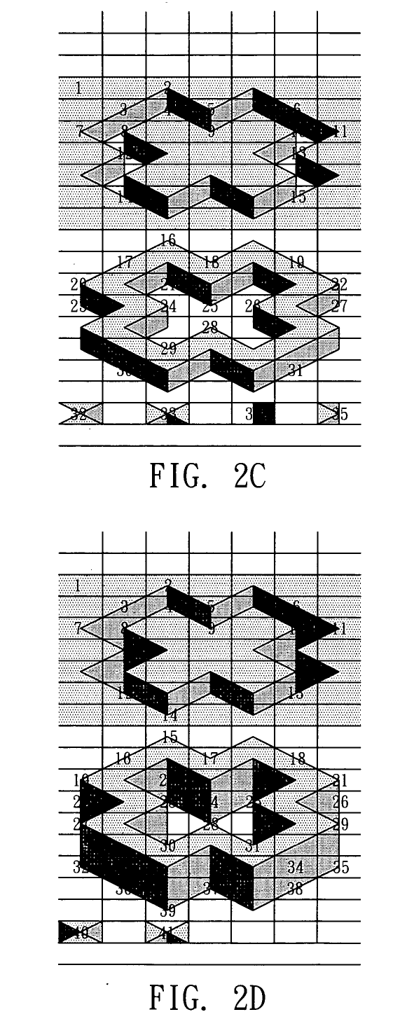

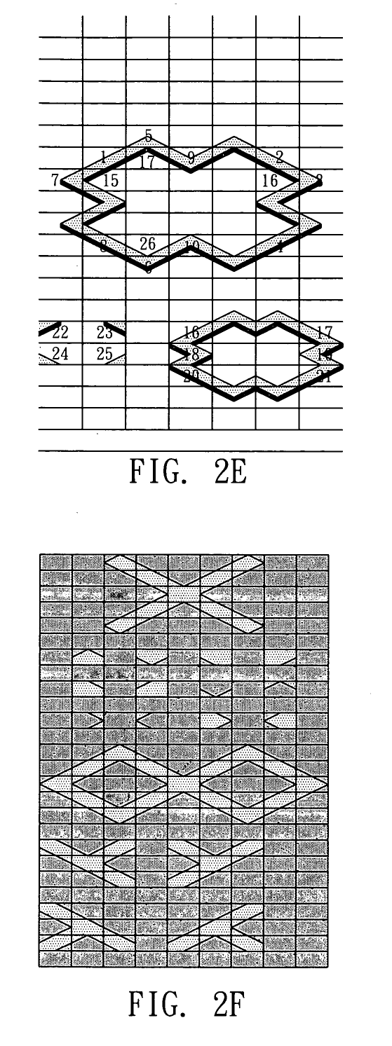

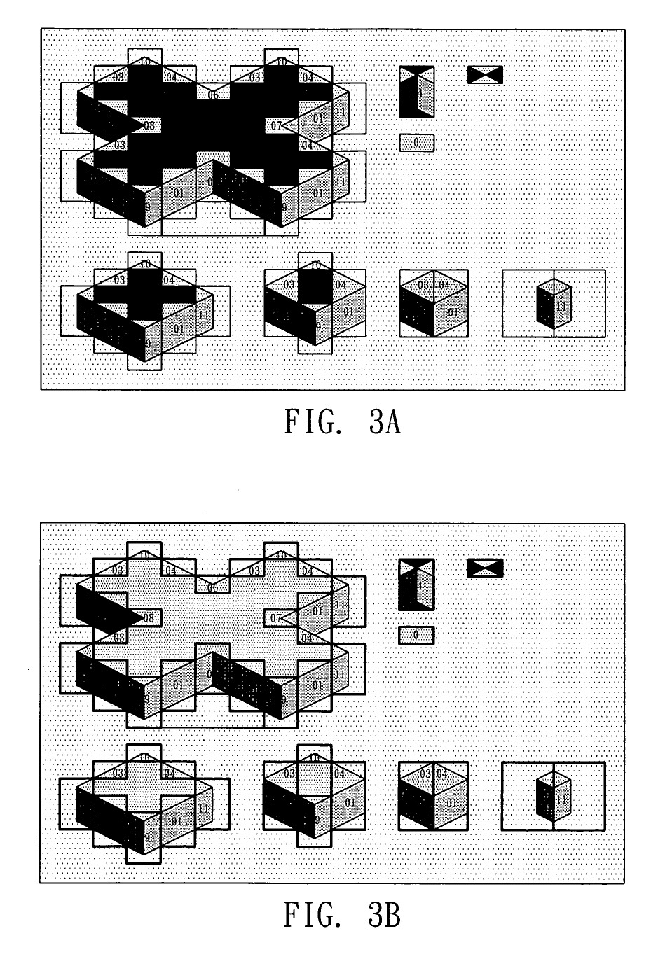

The database 101 stores various types of basic templates, wherein, the basic template types refer to entitative types to which the basic templates belong. As shown in FIG. 2A, “TYPE1” is a template for making flat lands; as shown in FIGS. 2B to 2E, “TYPE2”, “TYPE3”, “TYPE4” and “TYPE5” are templates for making terrains with different thickness; FIG. 2F shows a template for making roads; and FIG. 3A shows a template for making walls or highlands. The database 101 further stores a plurality of basic graphic units corresponding to the different types of basic templates. Referring to FIG. 2A, there are fifteen basic graphic units in the “TYPE1” template. A user can put the fifteen basic graphic units together in different combinations, so as to obtain different shapes of entitative graphs. But it should be noted that the number of the basic graphic units contained in different types of templates is different. For example, the “TYPE2” template of FIG. 2B has 29 basic graphic units, the “TYPE3” template of FIG. 2C has 35 basic graphic units, the “TYPE4” template of FIG. 2D has 41 basic graphic units, and the “TYPE5” template of FIG. 2E has 26 basic graphic units.

The decomposing module 110 is used to create a graphic baseplate, and decompose the graphic baseplate into a plurality of graphic chips based upon a user's requirement. In the present embodiment, the graphic chips are all the same in shape and size. Meanwhile, in order to provide an optimum visual effect for three-dimension graphs, the shape of the graphic chips is defined as a rectangular, ratio of length to width of which is 2:1. In addition, since area size of each of the graphic chips makes a direct influence on the visual effect of the final graphs, size of the graphic chips can be defined as 64*128 pixels. But it should be noted that definition of shape and size of the graphic chips is not limited thereto. On the contrary, the shape and size of the graphic chips can be arbitrarily changed according to actual design requirements.

The setting module 120 is provided for a user to select a basic template type from the database 101 according to design requirement. For example, when a user needs to draft a flat land, the user can select the basic template of “TYPE1” (shown in FIG. 2A) from the database 101, and acquire basic graphic units corresponding to the basic template of “TYPE1” from the database 101.

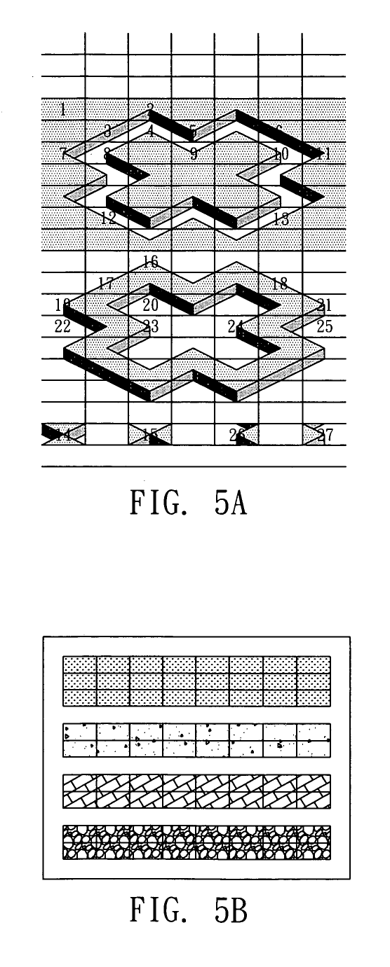

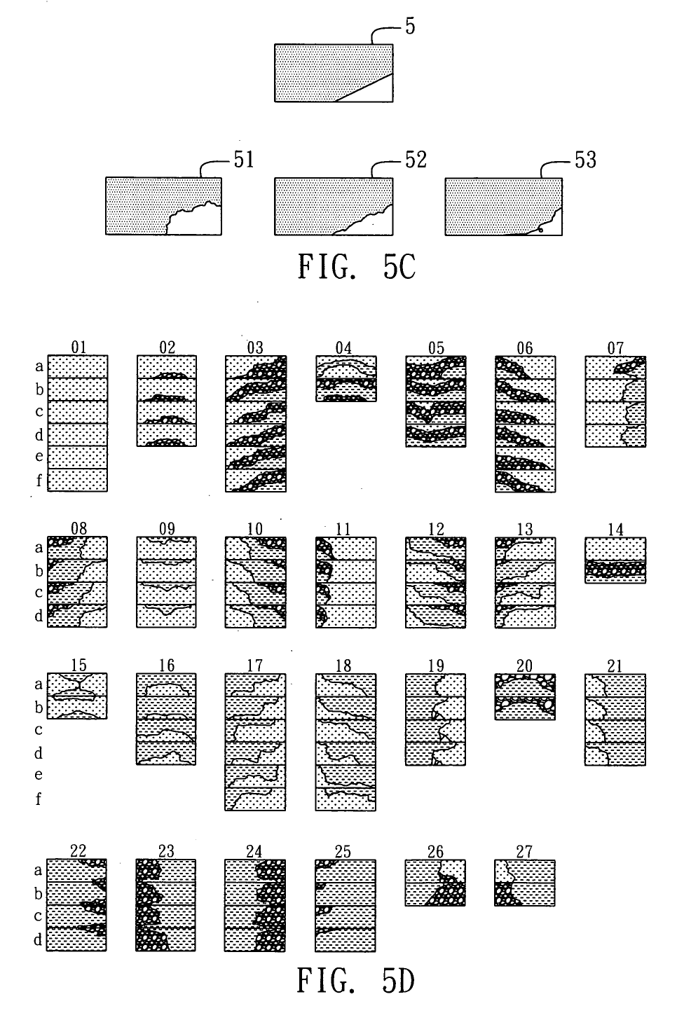

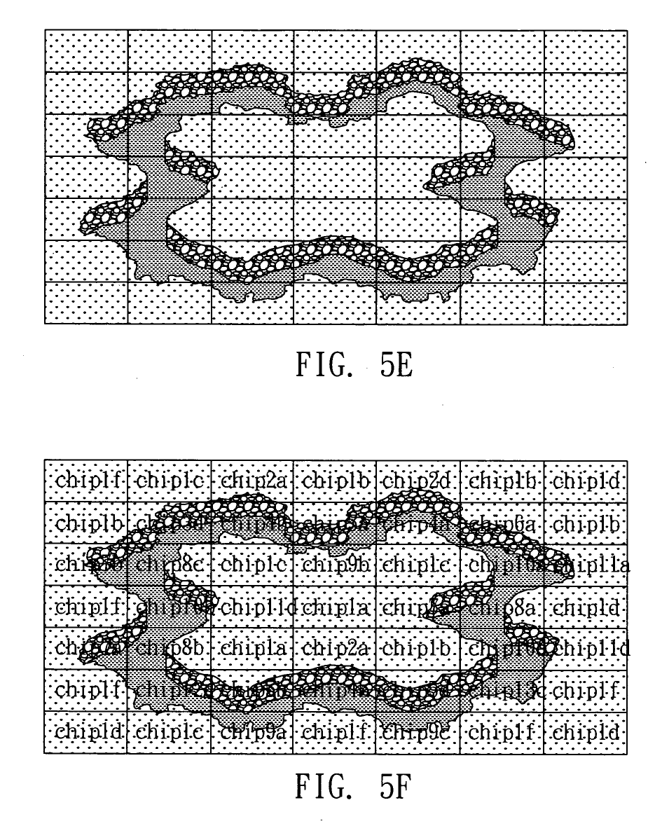

The decorating module 130 is used to decorate the basic graphic units based upon actual requirements. In the present embodiment, the decorating module 130 can be used to modify texture of the basic graphic units. For example, FIG. 5B shows four types of textures for decorating a ground. In addition, each of the basic graphic units can contain a plurality of textures at the same time, and the plurality of textures is separated from each other by partition lines. The decorating module 130 can also decorate shape of the partition lines. As shown in FIG. 5C, a straight partition line of the basic graphic unit 5 is decorated through the decorating module 130 so as to obtain a plurality of graphic units 51, 52 and 53 with different shapes of partition lines. FIG. 5D shows a plurality of graphic units formed by respectively decorating the basic graphic units of the “TYPE2” template in FIG. 2B. It should be noted that in the present embodiment, in order to assure the combining effect of the basic graphic units, the decorating module 130 only decorates the shape of the partition lines, i.e., intersection points between the partition lines and border lines of the basic graph units containing the partition lines are kept unchanged.

The filling module 140 is used to fill the basic graphic units into the graphic chips at corresponding positions respectively. Therein, the basic graphic units and the graphic chips into which the basic graphic units are filled are matched in shape and size. Thereby, various shapes of entitative graphs can be obtained. As shown in FIG. 3A, a cross-shaped wall with a hollow structure is obtained by combining the basic graphic units. When a user fills a basic graphic unit “0” into each of the graphic chips in district “A” respectively, a cross-shaped house having a roof and walls can be achieved as shown in FIG. 3B. By replacing the basic graphic unit “11” with a basic graphic unit “14”, the wall of FIG. 3A can easily be extended. Similarly, by replacing the basic graphic units “07” or “08” with a basic graphic unit “13”, the shape and structure of the wall can be modified. Therefore, a user only needs to decorate the basic graphic units corresponding to the graphic chips through the decorating module 130 so as to obtain various graphs with different shapes and entitative types.

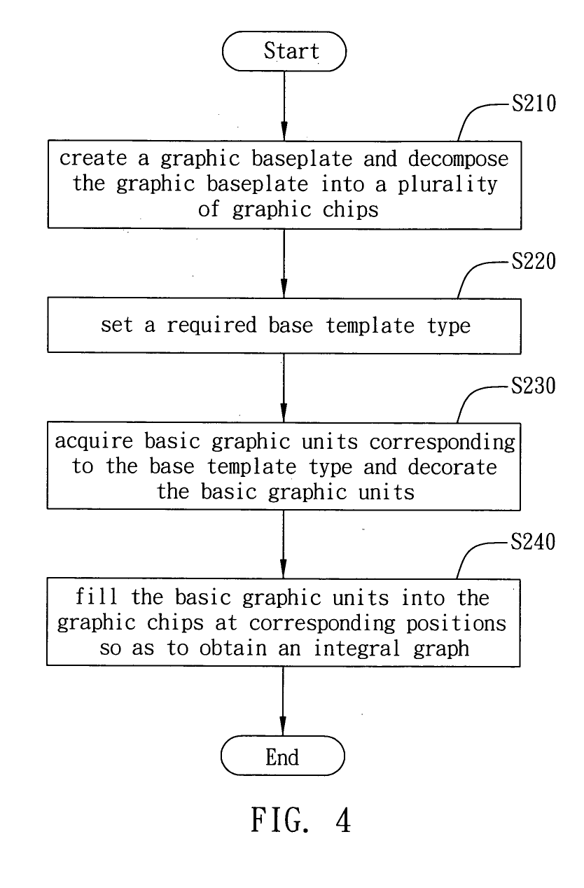

FIG. 4 is a flow chart of a graph making method according to the present invention. As shown in FIG. 4, first at step S210, a blank graphic baseplate is created, and then the graphic baseplate is decomposed into a plurality of rectangular graphic chips. The ratio of length to width of the rectangular graphic chips is 2:1. Then, the process flow proceeds to step S220.

At step S220, a basic template type is selected from a database 101 according to design requirements. In the present embodiment, if a terrain picture (as shown in FIG. 5E) is required to be painted, a user can select a corresponding basic template (as shown in 5A) from the database 101 according to thickness of the terrain. Then, the process flow proceeds to step S230.

At step S230, basic graphic units corresponding to the basic template type are acquired and decorated. First, texture of the basic graphic units can be decorated. For example, FIG. 5B depicts some textures for making a ground. Then, shape of partition lines of the basic graphic units can be decorated. In the present embodiment, as shown in FIG. 5D, a plurality of graphic units are formed by decorating 27 basic graphic units contained in the selected basic template respectively, and the graphic units are then stored in the database. By putting the graphic units together in different combinations, various kinds of graphs can be obtained without repetition, thereby avoiding graph monotony. Then, the process flow proceeds to step S240.

At step S240, the decorated basic graphic units are filled into the graphic chips at corresponding positions respectively so as to form various entitative graphs with different shapes, thereby obtaining a needed terrain graph as shown in FIG. 5F.

Therefore, the graph making system and method according to the present invention can achieve the following effects.

(1) The present invention can improve working efficiency of a game scene developer. Since a graph is obtained by combining a plurality of units, to modify a scene picture, a game scene developer merely needs to modify the contents filled in part of the graphic chips in the scene picture or change the combination way of the basic graphic units, thereby alleviating drafting burden of the game scene developer.

(2) The present invention can save computer resources. To display a game scene picture created by the present invention, instead of memorizing resources of the whole picture, a computer merely needs to memorize position of each of the graphic chips and serial number of the basic graphic units filled to the graphic chips.

(3) The present invention can upgrade operation speed of system programs. For example, to display an ocean picture formed by putting 12 identical basic graphic units having a size of 3*4 pixels together, a computer only needs to memorize information of one of the basic graphic units, read position coordinates of the 12 basic graphic units, and display the ocean picture through a “multiplication” operation. Compared with the conventional technology that displays a picture by scanning row by row (i.e., in an “addition” operation), the present invention can efficiently increase operation speed, improve display effect of game pictures, and meanwhile increase game interest.

The above-described exemplary embodiments are to describe various objects and features of the present invention as illustrative and not restrictive of the scope of the essential technical content according to the present invention, the essential technical content of the present invention is broadly defined in the appended claim, if the exemplary embodiments or method implemented by any one are completely identical to the following claim or only an equivalent change of the following claim, all that is considered to fall with the scope of the invention.

What is claimed is:

1. A graph making system for designing and making graphs, the system comprising:
a database for storing various types of basic templates and a plurality of basic graphic units respectively corresponding to the various types of basic templates;
a decomposing module for creating a graphic baseplate, and decomposing the graphic baseplate into a plurality of graphic chips;
a setting module for selecting a basic template type from the database according to the design requirement and acquiring basic graphic units corresponding to the basic template type from the database; and
a filling module for filling the basic graphic units into the plurality of graphic chips at corresponding positions respectively so as to form various entitative graphs with different shapes, thereby obtaining an integral graph.

2. The graph making system of claim 1, wherein the basic templates are classified according to entitative types to which the basic templates belong.

3. The graph making system of claim 2, wherein each of the entitative types is one of a ground, a wall and a road.

4. The graph making system of claim 1, wherein each of the graphic chips is in a shape selected from a square and a rectangle.

5. The graph making system of claim 1, wherein the basic graphic units and the graphic chips into which the basic graphic units are filled are matched in shape and size.

6. The graph making system of claim 1, further comprising a decorating module for decorating the basic graphic units based upon actual requirements.

7. The graph making system of claim 6, wherein the decorating module is used to decorate texture of the basic graphic units.

8. The graph making system of claim 1, wherein, each of the basic graphic units comprises at least one partition line and the partition line is composed of at least a straight line.

9. The graph making system of claim 8, wherein the shape of the partition line can be decorated by the decorating module.

10. The graph making system of claim 1 being applicable to the scene development of computer games.

11. The graph making system of claim 10, wherein the computer scene is three-dimensional.

12. A graph making method for designing and making graphs through a graph making system, wherein the graph making system has a database for storing various types of basic templates and a plurality of basic graphic units respectively corresponding to the various types of basic templates, the graph making method comprising:
(1) creating a graphic baseplate, and decomposing the graphic baseplate into a plurality of graphic chips;
(2) setting a required basic template type and acquiring basic graphic units corresponding to the basic template type; and
(3) filling the basic graphic units into the graphic chips at corresponding positions respectively so as to form various entitative graphs with different shapes, thereby obtaining an integral graph.

13. The graph making method of claim 12, wherein the basic templates are classified according to entitative types to which the basic templates belong.

14. The graph making method of claim 13, wherein each of the entitative types is one of a ground, a wall and a road.

15. The graph making method of claim 12, wherein the shape and size of the plurality of graphic chips formed at step (1) can be the same or different from each other.

16. The graph making method of claim 12, wherein the basic graphic units and the graphic chips into which the basic graphic units are filled are matched in shape and size.
